(19) United States
(12) Patent Application Publication
(10) Pub. No.: US 2017/0138078 A1
(43) Pub. Date: May 18, 2017

(54) Flexible Water Ejection Spout for a Swimming Pool Cover Pump

(71) Applicant: Joseph T. Acklin, Carmel, IN (US)

(72) Inventor: Joseph T. Acklin, Carmel, IN (US)

(21) Appl. No.: 15/369,763

(22) Filed: Dec. 5, 2016

Related U.S. Application Data
(63) Continuation-in-part of application No. 14/176,294, filed on Feb. 10, 2014, now Pat. No. 9,518,400.
Application No. 14/176,294 is a continuation-in-part of application No. 13/967,033, filed on Aug. 14, 2013, now Pat. No. 9,512,965.

(51) Int. Cl. E04H 4/14; B05B 11/00

(52) U.S. Cl. CPC E04H 4/14; B05B 11/30; B05B 11/0089

(57) ABSTRACT

A flexible water ejection spout for a swimming pool cover pump, is characterized by a conduit made at least partially, or having at least one portion, of a repeatedly positionable flexible material. The flexible water ejection spout has a connector at one end of the conduit that is configured to connect to a water outlet of the swimming pool cover pump, and a nozzle at the other end of the conduit. The flexible conduit or flexible portion(s) thereof can be repeatedly manipulated into any desired shape to provide infinite adjustment to the direction and inclination of the outgoing stream of water from the swimming pool cover pump and thus the swimming pool cover. The swimming pool cover pump may be fitted with the present flexible water ejection spout either via its releasable connector, or permanently, wherein the connector is replaced a permanent attachment.

### CROSS-REFERENCE TO RELATED APPLICATIONS

This U.S. non-provisional patent application is a continuation-in-part of co-pending U.S. non-provisional patent application Ser. No. 14/176,294 filed Feb. 10, 2014 titled “Swimming Pool Cover Pump With Integral Water Ejection Spout,” which is a continuation-in-part of U.S. non-provisional patent application of co-pending U.S. non-provisional patent application Ser. No. 13/967,033 filed Aug. 14, 2013 titled “Method and Device for Removing Water From a Swimming Pool Cover,” the entire contents of each of which is specifically incorporated herein by reference.

### FIELD OF THE INVENTION

The present invention relates to devices for removing water from a swimming pool cover and, more particularly, to devices for removing water from a swimming pool cover using a swimming pool cover pump.

### BACKGROUND

Many swimming pools have covers for keeping dirt, debris and other undesirable elements from getting into the pool. Covers also keep children from falling into the pool when the pool is unattended, and unauthorized people from entering the pool. Covers are thus made to withstand substantial weight so that if someone were to fall or walk onto the cover it would hold their weight.

However, because of the various purposes of a swimming pool cover, they are made such that they are impermeable to water. Therefore, water, generally because of rain, accumulates on the swimming pool cover. In order to use the swimming pool, any water on the cover must first be removed before the cover can be manually taken off or automatically rolled back. The prior art manner of removing water from a pool cover is to use a pool cover pump.

FIG. 1 shows a typical swimming pool 10 with a cover 12. While the cover 12 is shown as an automatic type pool cover, it should be appreciated that the same prior art method applies to manual type pool covers. An accumulation of water 14 is shown on the cover 12. A typical pool cover pump 16 has been placed in the accumulation of water 14. The pool cover pump 16 operates via electricity and thus includes a power cord 17 that is connected to a source of electricity (not shown). The pump 16 has a connector 19 through which the water is pumped. The pump connector 19 is configured (i.e. threaded) such that a typical hose 18 can be connected to the pump 16. This setup guides the accumulated water 14 from the cover 12 and out the hose 18.

While the prior art manner of removing water from a swimming pool cover certainly works, there are many associated hassles, particularly with the hose and the water being removed. First, a hose of sufficient length to channel the water to a desired outflow area must be connected to the pool cover pump, and secondly, the hose 18 must be connected to the pool cover pump, stretched out and appropriately placed such that the pumped water flows into the desired outflow area. This procedure must be accomplished every time accumulated water is removed from the pool cover.

Moreover, the water being removed flows from the hose 18 in a large continuous stream. As such, the continuous stream of water from the hose is not well suited for anything other than wasting the water. If the hose is placed such that the continuous stream of water outflows into a yard, the outflow area will quickly become saturated.

In view of the above, what is therefore needed is a better manner of removing accumulated water from a swimming pool cover.

### SUMMARY OF THE INVENTION

The present invention is a flexible water ejection spout for removing accumulated water from a swimming pool cover that streams outflowing water from a swimming pool cover pump in the form of a directed stream or spray.

The flexible water ejection spout is characterized by a conduit having at least portions thereof made of a repeatedly positionable flexible material and including a connector at one end of the conduit that is configured to connect to a water outlet of a swimming pool cover pump, and a nozzle at the other end of the conduit that is configured to eject water. The flexible conduit or the flexible portion(s) thereof can be repeatedly bent into any shape as desired to provide infinite adjustment to the direction and inclination of the outgoing ejection of water from the swimming pool cover pump and thus the swimming pool cover.

The nozzle of the flexible water ejection spout may be integrally formed with or into the conduit, or it may be separately made and attached to the conduit. The nozzle may be associated with, attached to, or a part of a repeatedly positionable flexible portion of the conduit to allow adjustment of the trajectory of the ejected water. The nozzle may have an internal configuration that increases the velocity of the outgoing stream of water in order to further project the outgoing stream of water from the swimming pool cover pump and thus the swimming pool cover regardless of spout configuration. The nozzle may have a configuration that allows adjustment of the velocity of the outgoing stream of water, regardless of spout configuration.

The connector of the flexible water ejection spout may be fashioned as appropriate to connect to the water outlet of the swimming pool cover pump, and may be integrally formed with or into the conduit, or it may be separately made and attached to the conduit. The nozzle may be associated with, attached to, or a part of a repeatedly positionable flexible portion of the conduit to allow adjustment of the trajectory of the ejected water. The flexible water ejection spout connector may, without being exhaustive, be threaded, be a quick-disconnect, or otherwise.

A swimming pool cover pump may be fitted with the present flexible water ejection spout either via its connector, or permanently wherein the connector of the flexible spout is replaced with a permanent connector/attachment.

Incorporation of the present flexible water ejection spout into a swimming pool cover pump provides various advantages over current swimming pool cover pumps. Such incorporation provides a quicker, cleaner and more convenient setup and removal of the swimming pool cover pump due to the lack of a garden hose. Another advantage is the infinite configuration adjustment of the flexible conduit to tailor the outgoing water to specific conditions, surroundings, settings, situations and circumstances.

### BRIEF DESCRIPTION OF THE DRAWINGS

FIG. 1 is an illustration of a prior art manner of removing water from a pool cover using a pool cover pump.

FIG. 2 is an illustration of a manner of removing water from a pool cover using a pool cover pump in accordance with the principles of the present invention, the present manner of removing water from a pool cover using a water ejection spout.

FIG. 3 is another embodiment of a water ejection spout fashioned in accordance with the present principles.

FIG. 4 is an illustration of the present manner of removing water from a pool cover using a pool cover pump with another embodiment of a water ejection spout.

FIG. 5 is an enlarged view of the water ejection spout connected to the pool cover pump as shown in FIG. 4.

FIG. 6 is an enlarged view of another embodiment of a water ejection spout fashioned in accordance with the present principles.

FIG. 7 is a view of a rotating nozzle for the present water ejection spouts according to the present principles.

FIG. 8 is a view of another water ejection spout fashioned in accordance with the present principles connected to a pool cover pump.

FIG. 9 is a view of another water ejection spout fashioned in accordance with the present principles connected to a pool cover pump.

FIG. 10 is an enlarged view of connecting portions of the water ejection spout of FIG. 9.

FIG. 11 is a view of a swimming pool cover pump having an integral water ejection spout in accordance with the present principles.

FIG. 12 is a view of another swimming pool cover pump having both an integral water ejection spout in accordance with the present principles and a threaded water outlet for connecting a garden hose, along with a user-controlled valve to select between water discharge from the water ejection spout and the garden hose water outlet.

FIG. 13 is a view of another swimming pool cover pump having both an integral water ejection spout in accordance with the present principles and a threaded water outlet for connecting a garden hose.

FIG. 14 is a view of a telescoping water ejection spout for the present swimming pool cover pump.

FIG. 15 is a view of a bendably positionable water ejection spout for the present swimming pool cover pumps.

FIG. 16 is an enlarged sectional view of a nozzle for the present water ejection spouts.

FIG. 17 is an embodiment of a flexible water ejection spout fashioned in accordance with the present principles.

FIG. 18 is a swimming pool cover pump utilizing the flexible water ejection spout of FIG. 17.

FIG. 19 is another embodiment of a flexible water ejection spout fashioned in accordance with the present principles.

### DETAILED DESCRIPTION

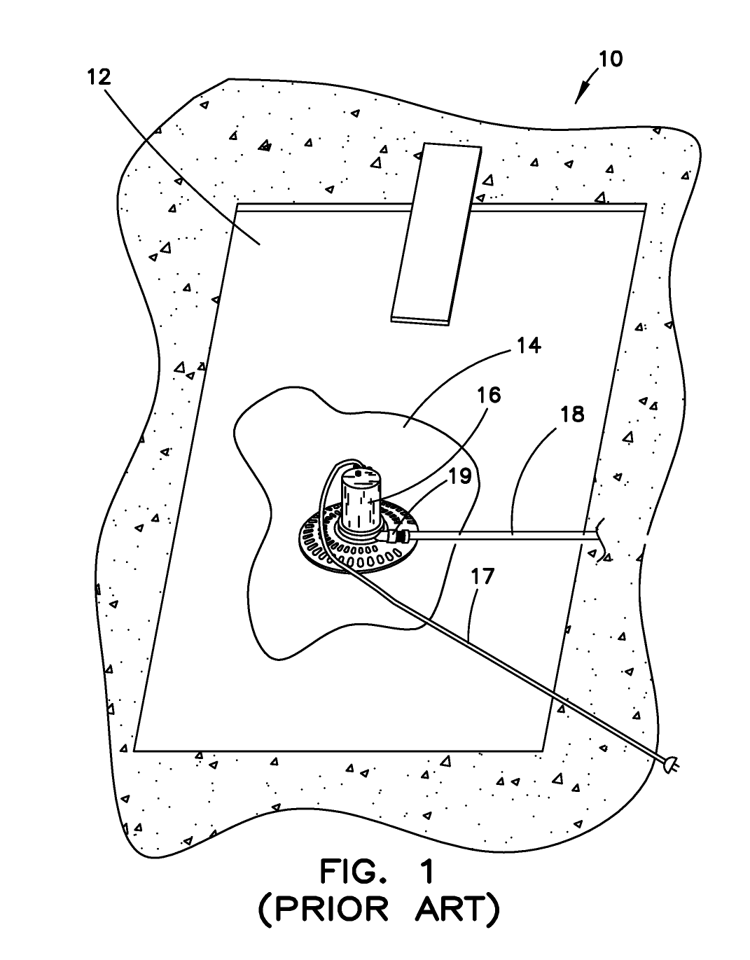

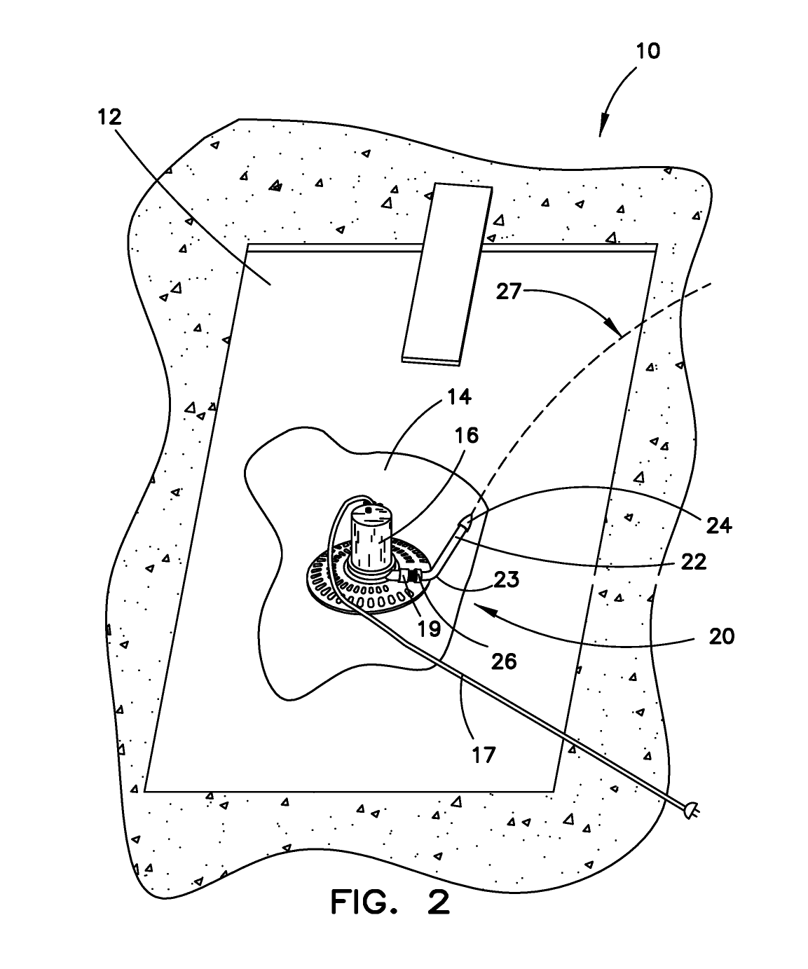

Referring to FIG. 2, there is shown the typical swimming pool 10 with a cover 12 as depicted in FIG. 1. While the cover 12 is shown as an automatic type pool cover, it should be appreciated that the present method and associated device applies to manual type pool covers. An accumulation of water 14 is shown on the cover 12. A typical swimming pool cover pump 16 has been placed in the accumulation of water 14. The swimming pool cover pump 16 operates via electricity and thus includes a power cord 17 that is connected to a source of electricity (not shown). The swimming pool cover pump 16 includes a connector 19 through which the accumulated water is pumped.

In accordance with the principles of the present invention, an exemplary embodiment of a water ejection spout 20 is connected to the swimming pool cover pump 16. The water ejection spout 20 is configured to discharge, spray, expel and/or otherwise disperse the accumulated water 14 in a stream 27. The water ejection spout 20 includes a length of tube/tubing, conduit, pipe/piping, or the like (collectively, tube) 22 that is preferably, but not necessarily, made from a plastic such as PVC. Other types of plastic and materials may be used if desired. Moreover, the tube 22 may be semi-rigid or bendable if desired. The length of tube 22 projects upwardly and outwardly from an angled portion 23 which in turn, is coupled to a connector 26. The connector 26 is threaded for attachment to the pump connector 19. A nozzle 24 is situated at an end of the tube 22. The nozzle 24 is configured to discharge, eject, expel, spray and/or otherwise disperse the outflowing stream of water 27 (collectively, stream) a distance up and away from the pool 10 and the pool cover 12. As such, the stream of water 27 is well suited for watering the lawn, directing the water to a desired outflow area, or otherwise controllably discharging the pumped water.

Because the water ejection spout 20 is rigid (or at least semi-rigid) the swimming pool cover pump 16 and thus the water ejection spout 20 is easily positionable on the pool cover 12 such that the direction of the water stream 27 is easily controlled. Thus, instead of moving a cumbersome hose, only the swimming pool cover pump 16 needs to be turned or otherwise positioned in order to direct the water stream 27 as desired.

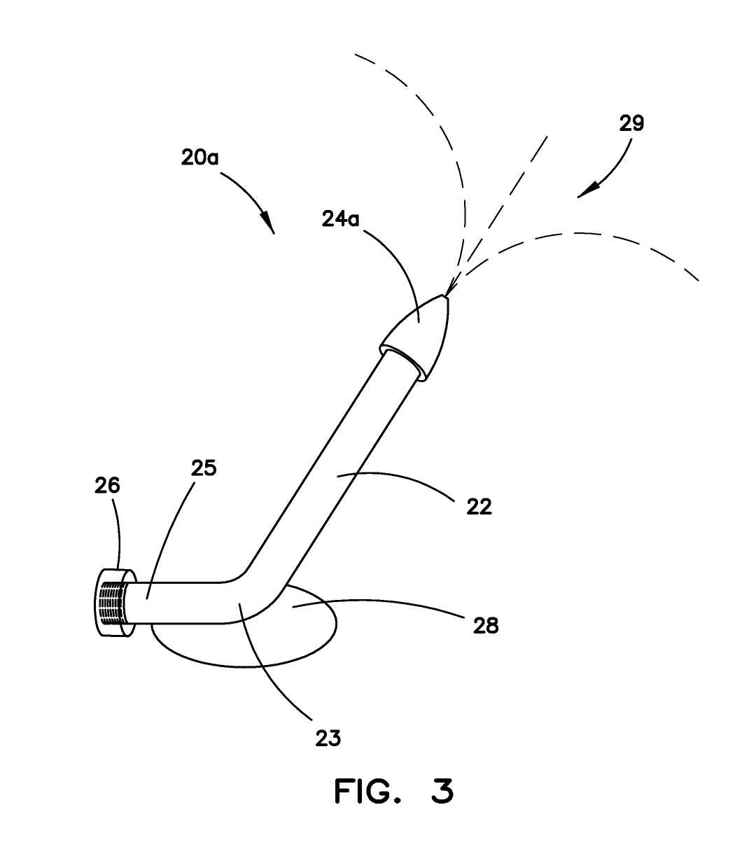

Referring now to FIG. 3, there is depicted another embodiment of a water ejection spout 20a fashioned in accordance with the present principles that is connectable to the swimming pool cover pump 16 (not shown in FIG. 3). The water ejection spout 20a is configured to expel and/or disperse the accumulated water 14 in a spray 29. The water ejection spout 20a includes the length of tube 22 like the water ejection spout 20. The length of tube 22 projects upwardly and outwardly from the angled portion 23 which in turn, is coupled to the connector 26 via an extended length of tube 25. The connector 26 is threaded for attachment to the pump connector 19. A nozzle 24a is again situated at an end of the tube 22. The nozzle 24a is configured to discharge, spray, eject, expel and/or otherwise disperse the outflowing spray of water 29 a distance up and away from the pool 10 and the pool cover 12. As such, the spray or stream of water 29 is well suited for watering the lawn, directing the water to a desired outflow area, or otherwise controllably discharging the pumped water.

The water ejection spout 20a includes a base 28 on which the extended length of tube 25 and the angled portion 23 rests. The base 28 provides extra stability to the water ejection spout 20 to inhibit and/or prevent it from tipping over. Because the water ejection spout 20a is rigid (or at least semi-rigid) the swimming pool cover pump 16 and thus the water ejection spout 20a is easily positionable on the pool cover 12 such that the direction of the water spray 29 is easily controlled. Thus, instead of moving a cumbersome hose, only the swimming pool cover pump 16 needs to be turned or otherwise positioned in order to direct the water spray 29 as desired.

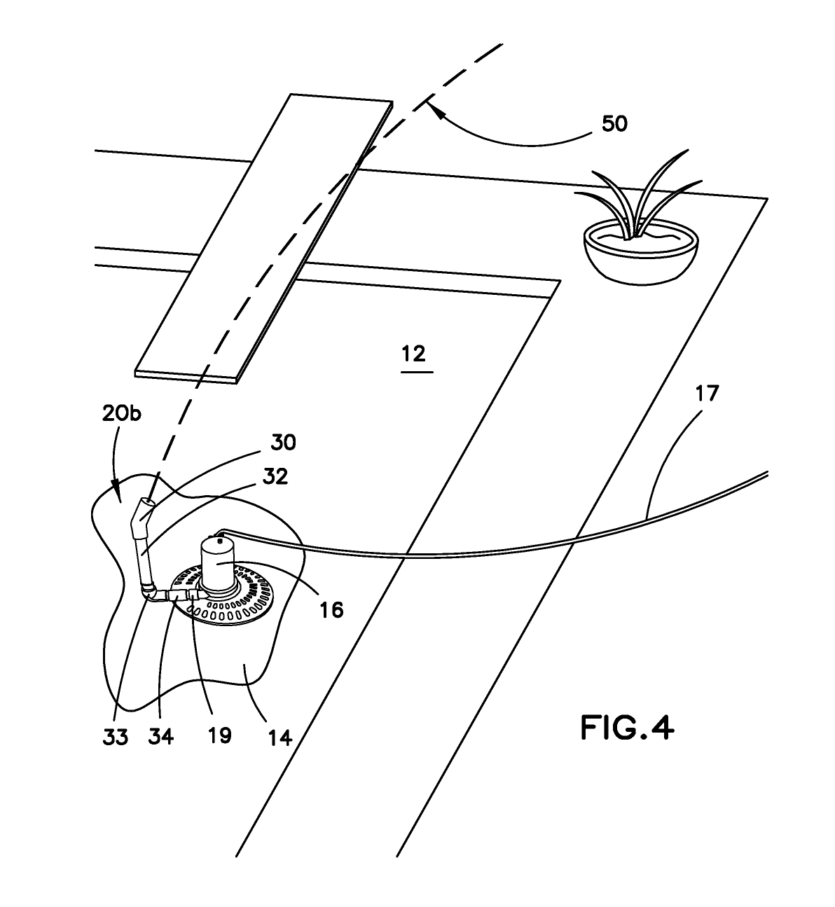

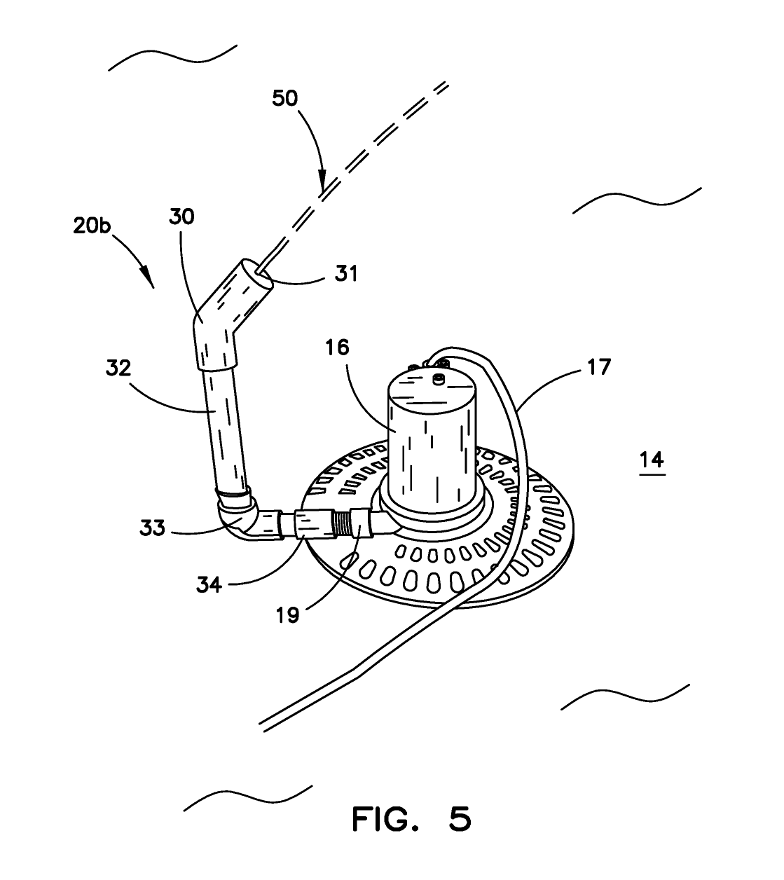

Referring now to FIGS. 4 and 5, there is shown another exemplary embodiment of a water ejection spout 20b fashioned in accordance with the present principles that is connectable to the swimming pool cover pump 16. The water ejection spout 20b is configured to discharge, spray, stream, expel and/or otherwise disperse the accumulated water 14 in a stream 50. In this embodiment, rather than expelling the water upwardly, outwardly and away from the pump as per the water ejection spouts 20 and 20a, the water is expelled upwardly, away and over the swimming pool cover pump 16. This helps to inhibit or prevent the force of the expelled water from rotating or otherwise affecting the position of the swimming pool cover pump 16.

The water ejection spout 20b includes connector 34 that is configured for threaded connection with the pump connector 19. An elbow 33, providing a right angle joint, is attached to the end of the connector 34. A length of tube 32 projects upwardly from the elbow 33. A nozzle 30 having a nozzle opening 31 is situated at an end of the tube 32. The nozzle 30 is angled such that the ejected outflowing stream of water 50 flows upwardly, outwardly and over the swimming pool cover pump 16 a distance away from the pool 10 and the pool cover 12. As such, the stream of water 50 is again well suited for watering the lawn, directing the water to a desired outflow area, or otherwise controllably discharging the pumped water. The direction of the ejected stream of water 50 counteracts any force exerted on the spout 20b and the swimming pool cover pump 16 such that the swimming pool cover pump 16 will not rotate or be moved thereby.

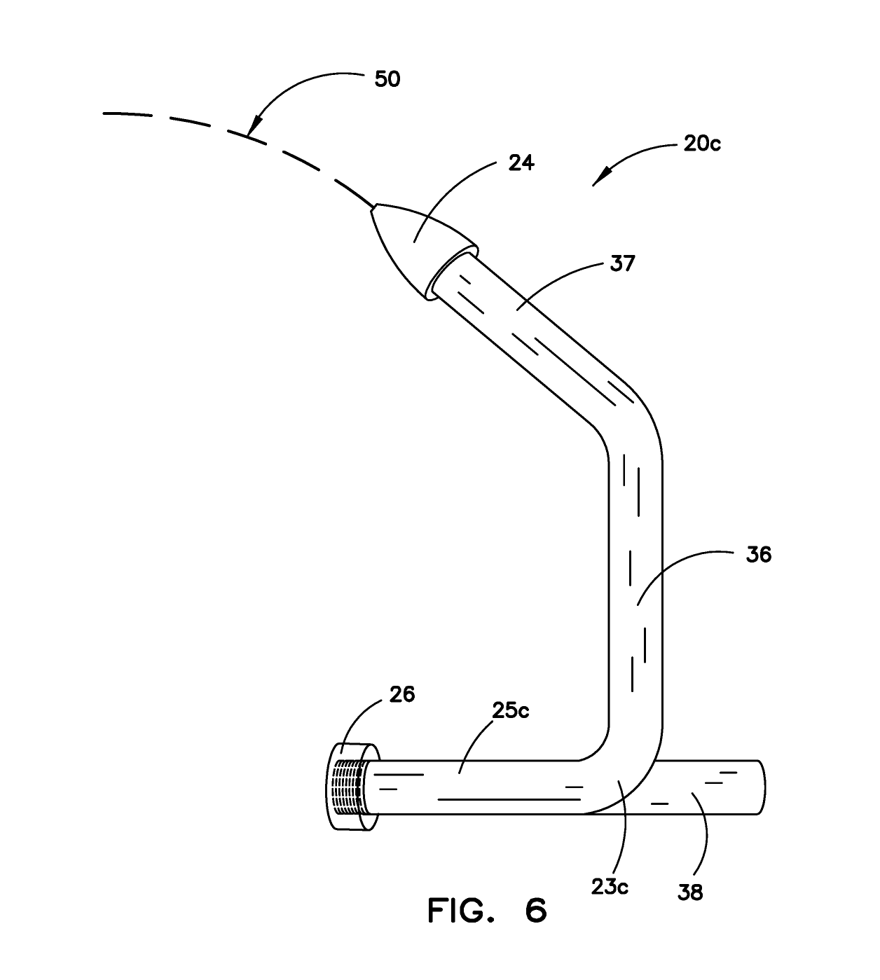

Referring now to FIG. 6, there is depicted yet another exemplary embodiment of a water ejection spout 20c fashioned in accordance with the present principles that is connectable to the swimming pool cover pump 16 (not shown in FIG. 6). The water ejection spout 20c, like the water ejection spout 20b, ejects, discharged, sprays, streams, expels and/or otherwise disperses the water upwardly, away and over the swimming pool cover pump 16. The water ejection spout 20c has a threaded connector 26 for connection to the pump connector, a straight length of tube 25c coupled to the connector 26, an angled portion 23c that provides a generally 90° bend, a second straight length of tube 36 extending upwardly from the angled portion 23c, and a third straight length of tube 37 that extends from the second length of tube 36 at an angle such that the nozzle 24 ejects a stream of water 50 upwardly, away from and over the pump (not shown in FIG. 6). The water ejection spout 20c further includes an extension 38 that projects from the straight length of tube 25c to provide stability to the water ejection spout 20c.

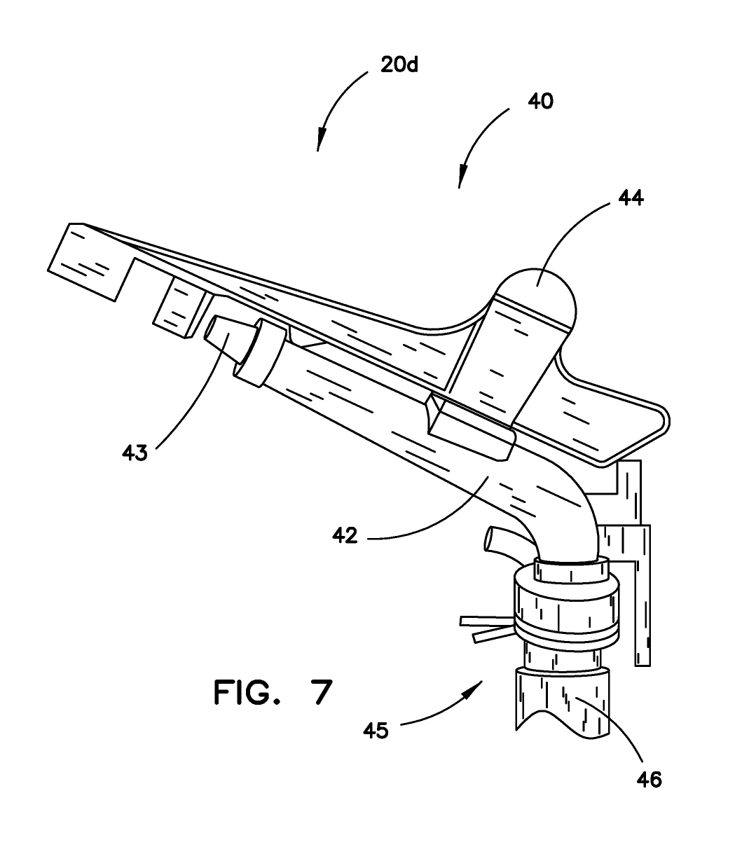

Referring now to FIG. 7, there is shown an alternate nozzle 40 for yet another exemplary embodiment of a water ejection spout 20d. While the nozzle 40 is described with respect to the water ejection spout embodiment 20d, it should be appreciated that the nozzle 40 may be used on any of the water ejection spouts described herein. The nozzle 40 is also representative of nozzles that provide a moving or adjustable spray or stream of water from the water ejection spout.

The nozzle 40 is illustrated as a typical rotating (moving) spray head. The nozzle 40 is situated on an end of a tube section 46 of the water ejection spout 20d. A curved tube section 42 extends from the tube section 46 and terminates in a water ejection head 43. A spring/rotation mechanism 45 is provided that is coupled to an actuating arm 44. Pressure from the ejected water causes the nozzle 40 to rotate as desired.

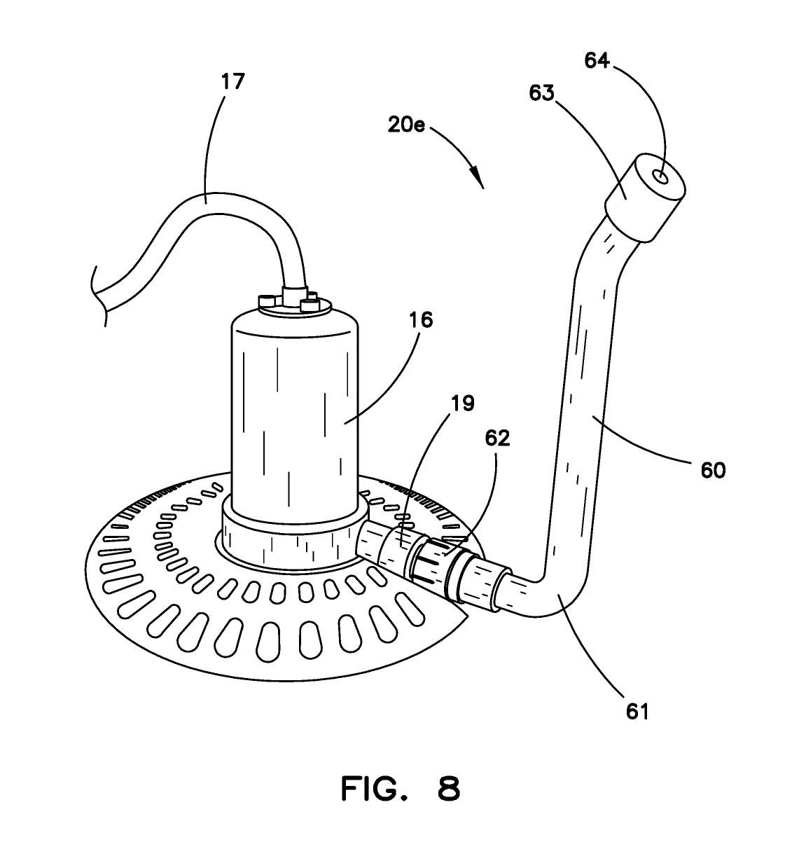

Referring now to FIG. 8, there is depicted a further embodiment of a water ejection spout 20e fashioned in accordance with the present principles that is connected to the swimming pool cover pump 16. The water ejection spout 20e is configured to discharge, spray, stream, expel and/or otherwise disperse the accumulated water 14 in a stream (not shown). The water ejection spout 20e includes a threaded connector section 62 that is configured for attachment to the threaded pump connector 19. An angled section 61 extends upwardly and slightly outwardly from the connector section. A length of generally linear (straight) tube 60 extends from the angled section 61 and includes an outward bend at its distal end. A nozzle 63 have an orifice 64 is situated at the end of the bend. The nozzle 63 is configured to eject, expel and/or disperse the outflowing stream of water (not shown) a distance away from the pool 10 and the pool cover 12.

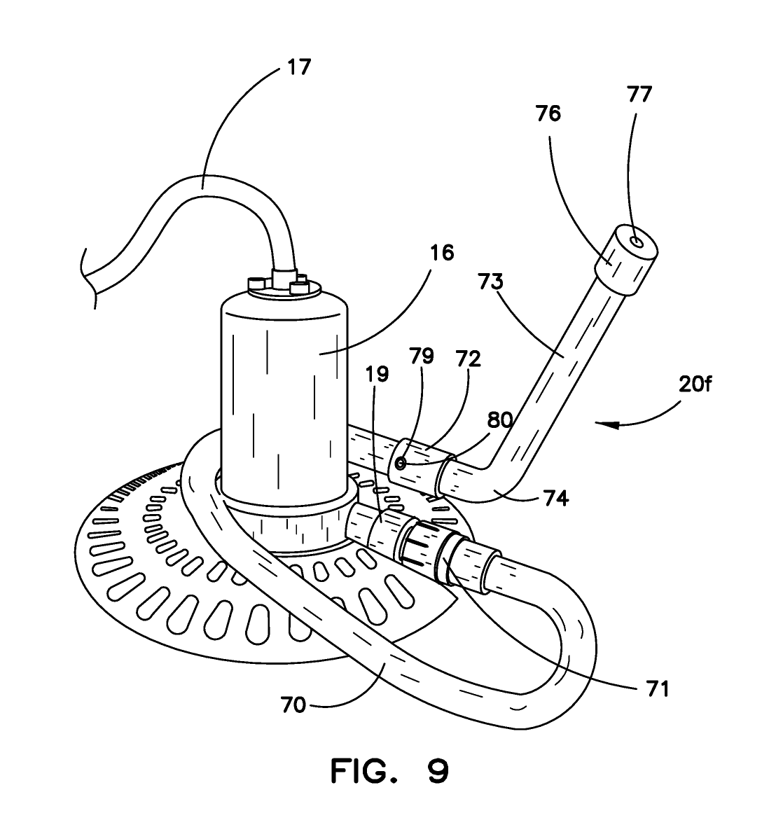

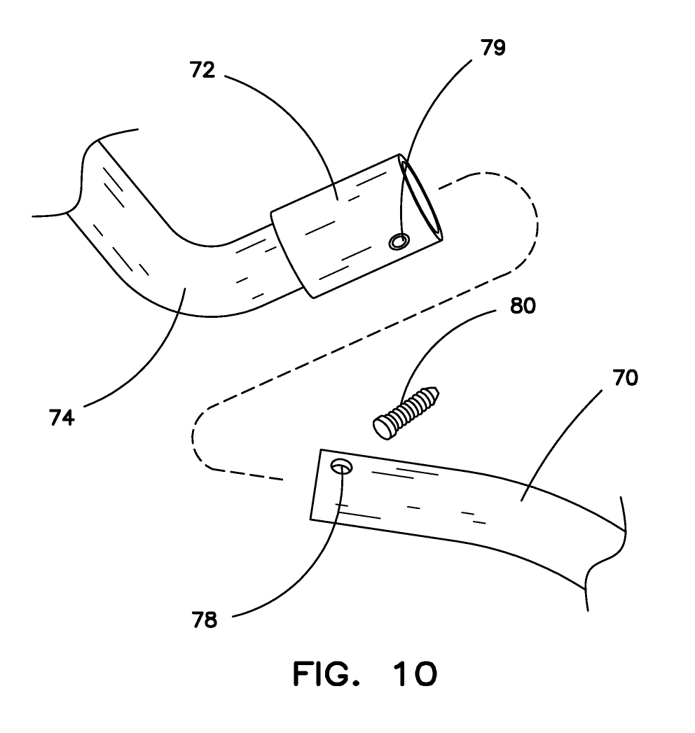

Referring to FIGS. 9 and 10, there is depicted a still further embodiment of a water ejection spout 20f fashioned in accordance with the present principles. The water ejection spout 20f is configured to address any possible rotation and/or tipping of the pool pump and connected water ejection spout that can be caused by the pressure of the outflowing water stream or spray. The water ejection spout 20f thus provides a water ejection spout that is anti-rotation and anti-tipping to the pump/spout configuration.

The water ejection spout 20f includes a threaded connector 71 that is configured to couple to the threaded pump connector 19. A first tube 70 extends from the connector 71 and is shaped to wrap around the pump 16. The first tube 70 has a bore 78 at its distal end. A second tube 73 having a bend 74 and a tube connector 72 at one end is adapted to allow connection of the first tube 70. The tube connector 72 has a bore 79 that aligns with the bore 78 of the first tube 70. A pin 80 or similar device is received in the bores 79 and 80 in order to secure the two tubes 70, 74 together. The tubes/tube sections 70 and 73 are separate to aid in packaging and/or storage of the water ejection spout 20f.

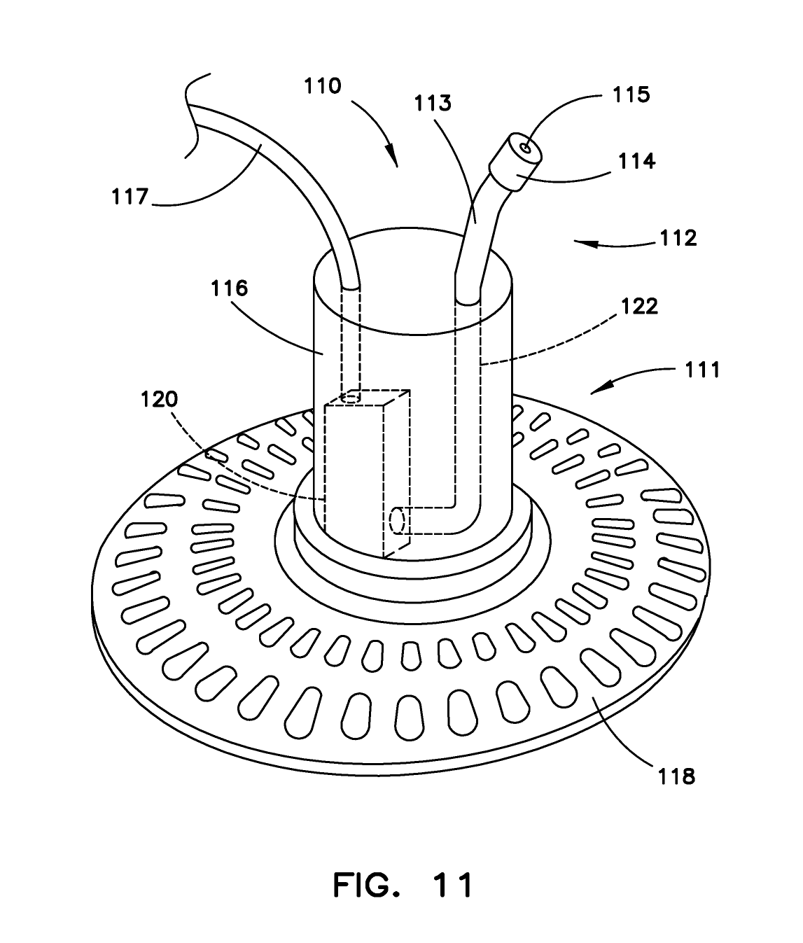

Referring to FIG. 11, there is shown a swimming pool cover pump having an integral or “built-in” water ejection spout, generally designated 110, fashioned in accordance with the present principles. Particularly, the swimming pool cover pump with integral water ejection spout 110 includes a swimming pool cover pump 111 with an integral water ejection spout 112.

The swimming pool cover pump 111 may be fashioned as a typical swimming pool cover pump having a housing 116 that encloses an electrically driven pump 120 having an inlet at the bottom of the housing 116. An electrical cord 117 supplies electricity to the electrical pump 120. A base 118 defining a debris screen is provided about the base of the pump housing 116.

Internal piping 122 extends between an outlet of the electrical pump 120 and the water ejection spout 112 which is situated at the top of the housing 116. Of course, the water ejection spout 112 may extend from a side of the housing 116 or other portion as desired. The water ejection spout 112 is characterized by a length of conduit or piping 113 having a nozzle 114 on its end. The internal piping 122 is in communication with the conduit 113 of the water ejection spout 112, with the conduit 113 in communication with the nozzle 114. The nozzle 114 has an orifice 115 that is configured to discharge water being pumped by the electrical pump 120 in the form of a spray, stream, jet or the like. The conduit 113 is preferably, but not necessarily, fixedly bent, curved or angled (configured) such that the nozzle 114 discharges the outgoing water, up, outwardly and/or away from the swimming pool cover (see, e.g., FIGS. 2 and 4).

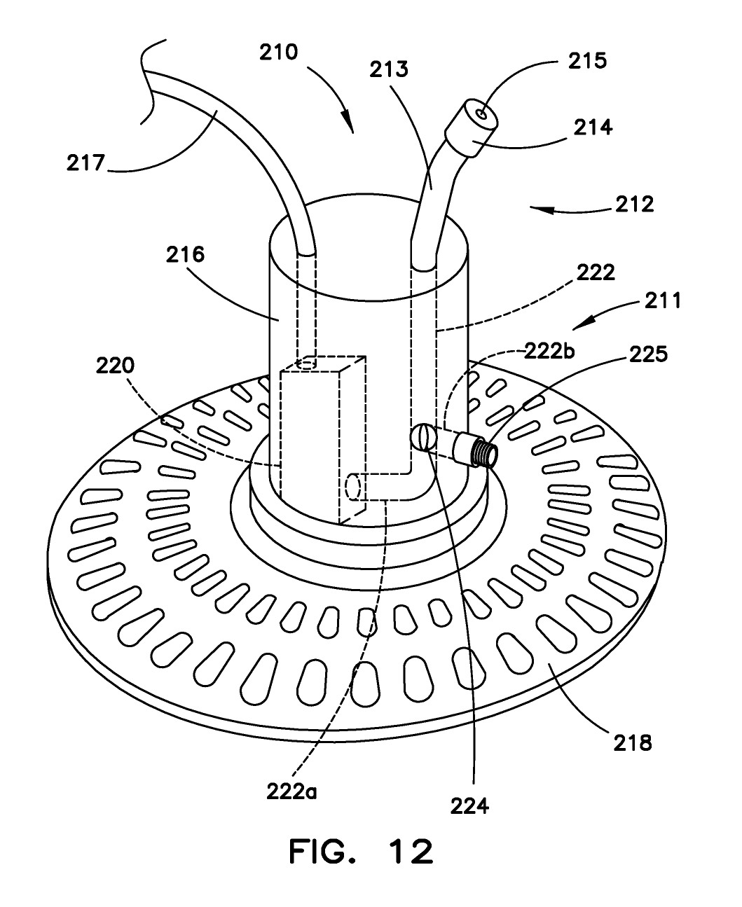

Referring to FIG. 12, there is shown another swimming pool cover pump having an integral or “built-in” water ejection spout, generally designated 210, fashioned in accordance with the present principles. Particularly, the swimming pool cover pump with integral water ejection spout 210 includes a swimming pool cover pump 211 with an integral water ejection spout 212 and a separate water outlet 225 fashioned in typical manner to accept a garden hose (not shown).

The swimming pool cover pump 211 may be fashioned as a typical swimming pool cover pump having a housing 216 that encloses an electrically driven pump 220 having an inlet at the bottom of the housing 216. An electrical cord 217 supplies electricity to the electrical pump 220. A base 218 defining a debris screen is provided about the base of the pump housing 216.

Internal piping 222a extends from the electrical pump 220 to a valve or switch 224. Piping 222 extends from the valve 224 to the water ejection spout 212 which is situated at the top of the housing 216. Of course, the water ejection spout 212 may extend from a side of the housing 216 or other portion as desired. The water ejection spout 212 is characterized by a length of conduit or piping 213 having a nozzle 214 on its end. The conduit 213 of the water ejection spout 212 is in communication with the nozzle 214. The nozzle 214 has an orifice 215 that is configured to discharge water being pumped by the electrical pump 220 in the form of a spray, stream, jet or the like. The conduit 213 is preferably, but not necessarily, fixedly bent, curved or angled (configured) such that the nozzle 214 discharges the outgoing water, up, outwardly and/or away from the swimming pool cover (see, e.g., FIGS. 2 and 4).

The valve 224 is also in communication with the water outlet 225. Particularly, internal piping 222b extends from the valve 225 to the water outlet 225. As indicated above, the water outlet 225 is configured to receive a garden hose. As such, the water outlet 225 has external threading to receive an internally threaded hose coupling of a typical garden hose (not shown). Other connection schemes may be used. The valve 224 fluidly connects either the water ejection spout 212 or the water (hose) outlet 225 to the electrical pump 220, thus allowing the user to select whether the pool cover water 14 being pumped by the electrical pump 220 is discharged by the water ejection spout 212 or through the water (hose) outlet 225.

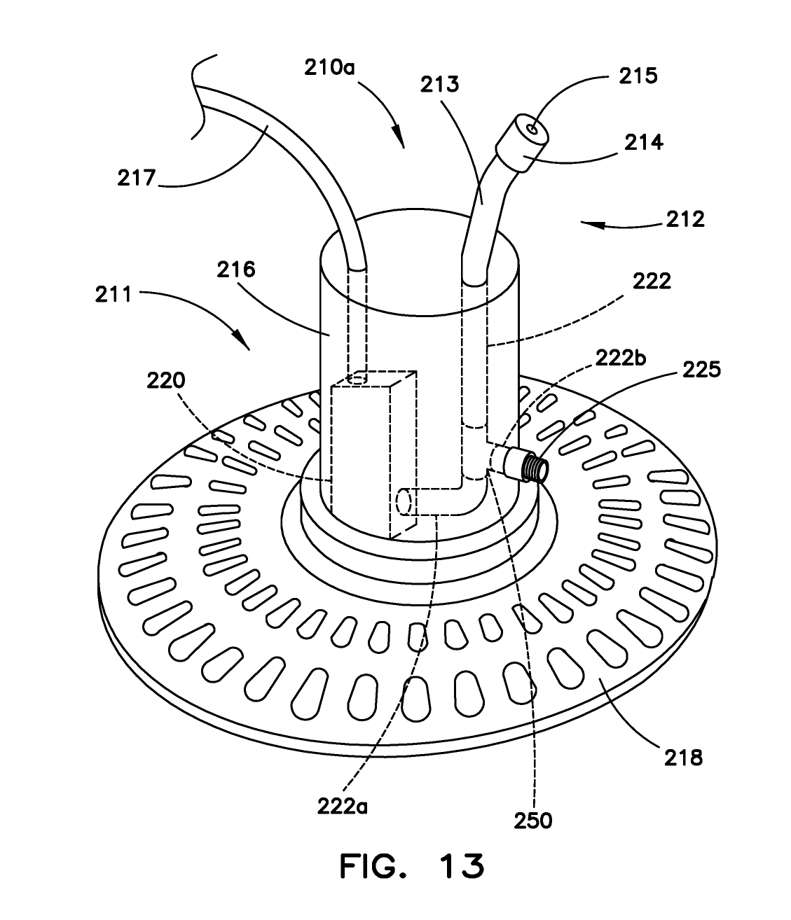

Referring to FIG. 13, there is shown another swimming pool cover pump having an integral or “built-in” water ejection spout, generally designated 210a, fashioned in accordance with the present principles. Particularly, the swimming pool cover pump with integral water ejection spout 210 includes a swimming pool cover pump 211 with an integral water ejection spout 212 and a separate water outlet 225 fashioned in typical manner to accept a garden hose (not shown) in like manner to the swimming pool cover pump 210 of FIG. 12.

The swimming pool cover pump 211 may be fashioned as a typical swimming pool cover pump having a housing 216 that encloses an electrically driven pump 220 having an inlet at the bottom of the housing 216. An electrical cord 217 supplies electricity to the electrical pump 220. A base 218 defining a debris screen is provided about the base of the pump housing 216.

Internal piping 222a extends from the electrical pump 220 to a T component 250 that splits the outgoing water flow from the electrical pump 220 into two outgoing water flows, one from a first water outlet and one from a second water outlet. Piping 222 extends from the first outlet of the T component 250 to the water ejection spout 212 which is situated at the top of the housing 216. Of course, the water ejection spout 212 may extend from a side of the housing 216 or other portion as desired. The water ejection spout 212 is characterized by a length of conduit or piping 213 having a nozzle 214 on its end. The conduit 213 of the water ejection spout 212 is in communication with the nozzle 214. The nozzle 214 has an orifice 215 that is configured to discharge water being pumped by the electrical pump 220 in the form of a spray, stream, jet or the like. The conduit 213 is preferably, but not necessarily, fixedly bent, curved or angled (configured) such that the nozzle 214 discharges the outgoing water, up, outwardly and/or away from the swimming pool cover (see, e.g., FIGS. 2 and 4).

The second water outlet of the T component 250 is connected to piping 222b which coupled to the water outlet 225. As indicated above, the water outlet 225 is configured to receive a garden hose. As such, the water outlet 225 has external threading to receive an internally threaded hose coupling of a typical garden hose (not shown). Other connection schemes may be used. The T component 250 fluidly connects both the water ejection spout 212 and the water (hose) outlet 225 to the electrical pump 220. In order to select one water outlet over the other water outlet, the user caps, plugs or otherwise blocks water flow from one of the two water outlets. This allows the user to select whether the water pumped by the electrical pump 220 is discharged by the water ejection spout 212 or through the water (hose) outlet 225.

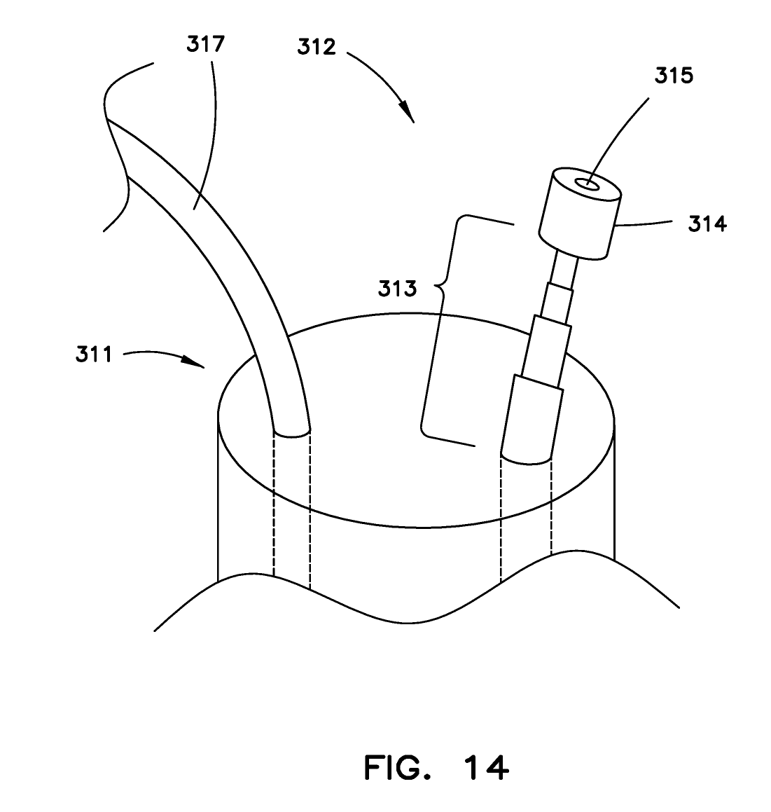

FIG. 14 shows an alternative embodiment of a water ejection spout, generally designated 313, that can be used with the present swimming pool cover pumps described herein. The water ejection spout 313 has telescoping piping 313 that extends from the swimming pool cover pump housing 311, in like manner to the previous water ejection spouts, to a nozzle 315. The telescoping piping 313 has a plurality of nesting piping sections that extend and contract such as is known in the art. The telescoping piping 313 may consist of as many nesting piping sections as desired to achieve a desired length when fully extended, thereby adjusting the orientation of the nozzle 325 and thus the directed stream of discharging water.

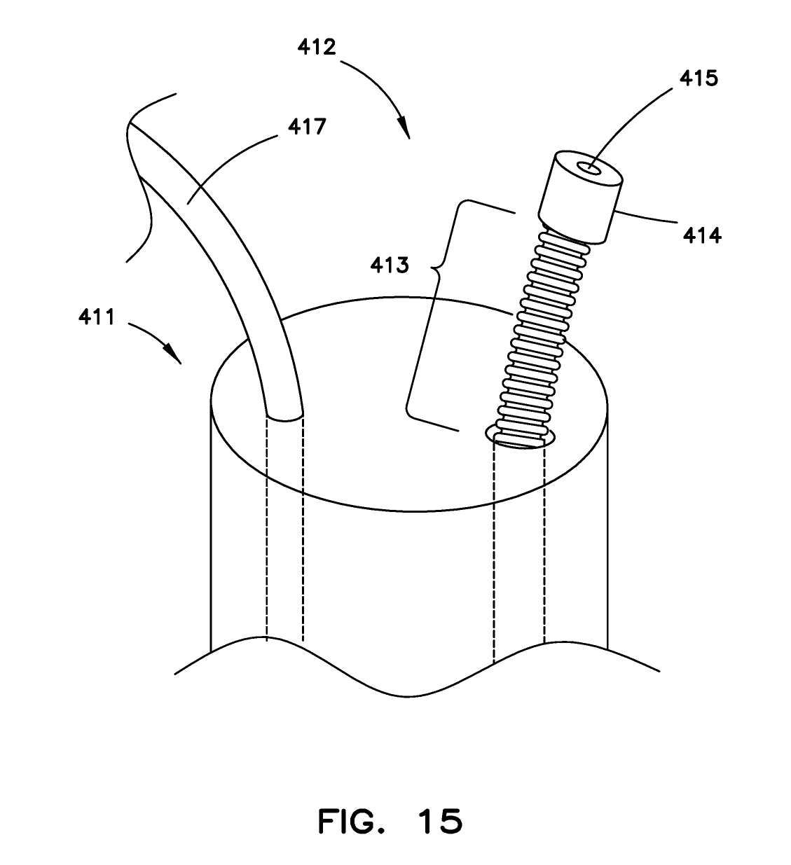

FIG. 15 shows an alternative embodiment of a water ejection spout, generally designated 413, that can be used with the present swimming pool cover pumps described herein. The water ejection spout 413 has flexible and bendable piping 413 that extends from the swimming pool cover pump housing 411, in like manner to the previous water ejection spouts, to a nozzle 415. As such, the piping 413 may be curved or shaped as desired in order to adjust adjusting the orientation of the nozzle 325 and thus the directed stream of discharging water.

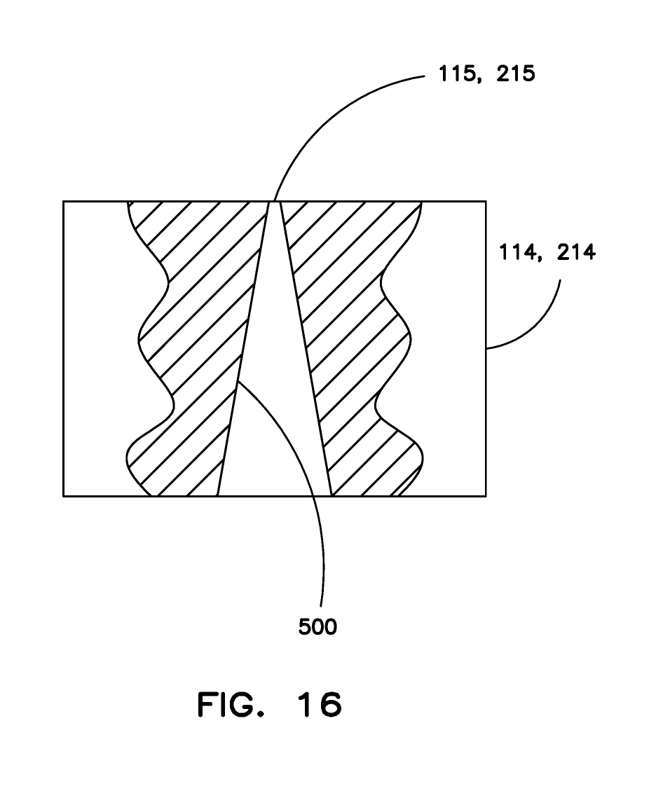

FIG. 16 shows the nozzle 114, 214 wherein the nozzle has an internal configuration that increases the velocity of the outgoing stream of water in order to further project the outgoing stream of water from the swimming pool cover pump and thus the swimming pool cover. Particularly, the nozzle has internal tapering 500 before the water orifice/outlet 115, 215 to increase the water pressure as the discharging water runs through the nozzle. This allows the water to be ejected further (greater distance and pressure) than a typical nozzle. Other manners of achieving increased velocity/water pressure are contemplated. The nozzle may further have a configuration that allows adjustment of the velocity of the outgoing stream of water. It should be appreciated that these nozzle features also apply to the stand-alone water ejection spouts. As well, the features of the stand-alone water ejection spouts are applicable to the nozzles of the integral pump version. Moreover, the stand-alone spouts may have a conduit of a fixed shape that provides a fixed direction and inclination of the outgoing stream of water. In another form, the stand-alone spout may have a telescoping conduit structure that provides telescoping adjustment to the direction and inclination of the outgoing stream of water. In yet another form, the stand-alone spout may have a bendable conduit that provides infinite adjustment to the direction and inclination of the outgoing stream of water. Other conduit and spout configurations of the stand-alone spouts for adjustment of the direction and/or inclination of the outgoing stream of water are contemplated.

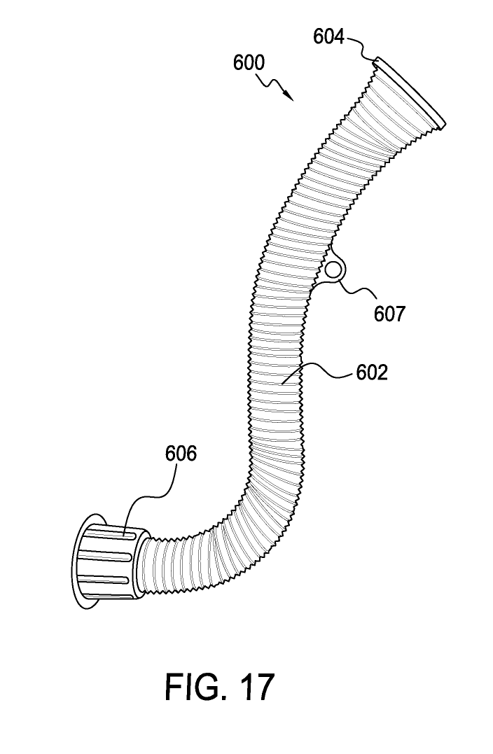

FIG. 17 depicts another water ejection spout, generally designated 600, fashioned in accordance with the present principles, that is usable in the same manner and for the same purpose as the other water ejection spouts shown and/or described herein. The water ejection spout 600 is a continuation of the water ejection spout 413 of FIG. 15 and its idea. As such, the water ejection spout 600 is characterized by a conduit, pipe, piping, hollow shaft, or the like 602 formed of a flexible material that can be repeatedly bent or manipulated without compromise, into any desired position or shape and remain in the desired position until manipulated into another shape. Various materials such as rubber, plastic, metal, and the like may be used either alone or in combination for the water ejection spout 600 and its components. As shown in FIG. 17, the flexible water ejection spout 600 has been manipulated into an ess. Of course, other shapes are contemplated.

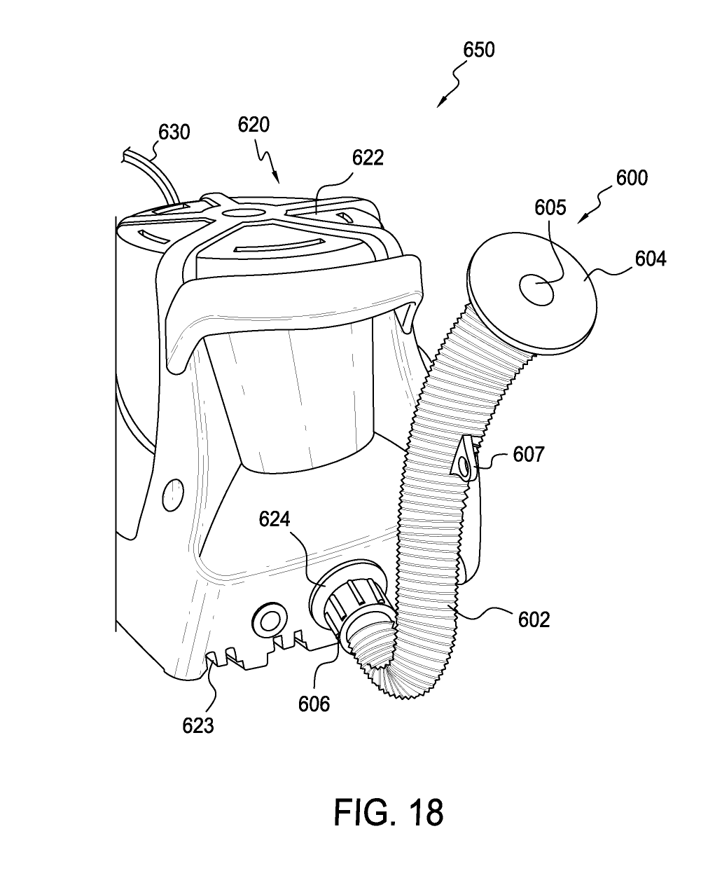

The flexible conduit 602 has a nozzle 604 at one end and a threaded connector 606 at another end. The nozzle 604 is preferably, but not necessarily, formed integral with or into the flexible conduit and includes an orifice 605 (see FIG. 18) for ejecting water from the flexible conduit 602. The nozzle 604 has the same attributes and/or characteristics as the various nozzles described herein and is thus configured accordingly. An optional, holed flange 607 may be provided on the flexible conduit 602 if desired. The threaded connector 606 is configured for releasable threaded engagement with a threaded outlet 624 of a swimming pool cover pump 620 (see FIG. 18). This provides fluid communication between the pump's water outlet and the flexible spout 600. Other types of connectors may be used between the swimming pool cover pump outlet and the flexible spout as necessary or desired, such as, but not limited to, quick disconnect, lugs, non-threaded, and the like.

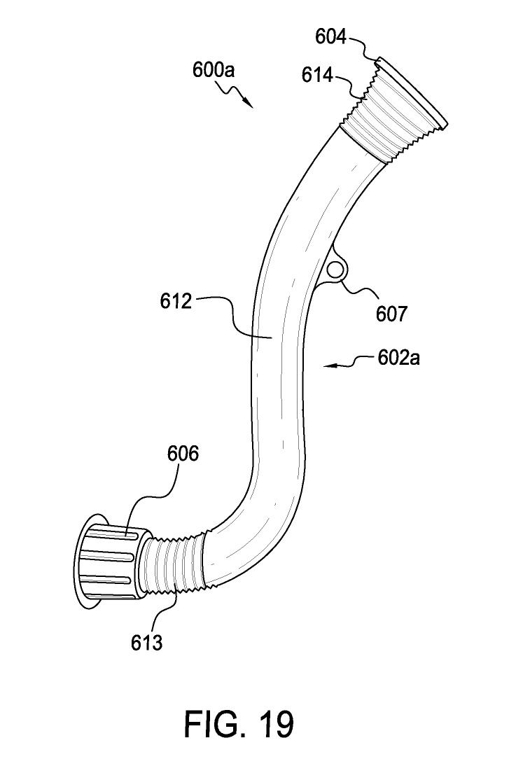

FIG. 19 depicts another water ejection spout, generally designated 600a, fashioned in accordance with the present principles, that is usable in the same manner and for the same purpose as the water ejection spout 600. The water ejection spout 600a is a variation of the entirely flexible, repeatedly positionable water ejection spout 600 of FIG. 17 and its idea. As such, the water ejection spout 600a is characterized by a conduit, pipe, piping, hollow shaft, or the like 602a formed partially of, or having one or more portions of, a flexible material that can be repeatedly bent or manipulated without compromise, into any desired position or shape and remain in the desired position until manipulated into another shape. Various materials such as rubber, plastic, metal, and the like may be used either alone or in combination for both any flexible and non-flexible portions of the water ejection spout 600a and its components. As shown in FIG. 19, the flexible water ejection spout 600a has been manipulated into an ess. Of course, other shapes are contemplated.

The conduit 602a has a non-flexible neck or middle portion 612 with a lower repeatedly positionable flexible portion 613 at one end of the middle portion 612, and an upper repeatedly positionable flexible portion 614 at the other end of the middle portion 612, the nomenclature upper and lower being arbitrary. A nozzle 604 is provided at the upper flexible portion 614 and a threaded connector 606 is provided at the lower flexible portion 613. The nozzle 604 is preferably, but not necessarily, formed integral with or into the flexible portion 614 and includes an orifice 605 (see, e.g., FIG. 18) for ejecting water from the conduit 602a. The nozzle 604 has the same attributes and/or characteristics as the various nozzles described herein and is thus configured accordingly. An optional, holed flange 607 may be provided on the middle section 612 if desired. The threaded connector 606 is configured for releasable threaded engagement with a threaded outlet 624 of a swimming pool cover pump 620 (see FIG. 18). This provides fluid communication between the pump's water outlet and the positionable spout 600a. Other types of connectors may be used between the swimming pool cover pump outlet and the positionable spout as necessary or desired, such as, but not limited to, quick disconnect, lugs, non-threaded, and the like.

The swimming pool cover pump 602 is shown in FIG. 18 as an electric pump that performs in the same manner as the other swimming pool cover pumps shown and described herein. Other types of swimming pool cover pumps, such as, but not limited to, battery powered, solar powered, with or without re-charging capabilities, may be used with all of the water ejection spouts described herein such as, but not limited to, the spouts 600, 600a. As is typical of swimming pool cover pumps, the pump 620 has a housing 622 with a water inlet 623 and the water outlet 624 that is externally threaded as indicated above. An electrical cord 630 provides electricity to the electric water pumping mechanism (not shown) of the pump 620 internal to the housing 622. Other particulars of the pump are not described since they are typical of swimming pool cover pump.

In FIG. 18, the flexible water ejection spout 600 is shown threadedly connected to the pump 620 to provide a water removal device 650 for a swimming pool cover. While the flexible spout 600 is releasably connected to the pump 620, it may be connected permanently if desired. Moreover, the positionable water ejection spout 600a may likewise be connected, coupled, or attached to the water outlet 624 of the pump 620 to provide a water removal device for a swimming pool cover.

Those of skill in the art will understand that various details of the present invention may be changed without departing from the spirit and scope of the invention. Furthermore, the foregoing description is for illustration only, and not for the purpose of limitation, the invention being defined by the claims. Moreover, the various features of the various embodiments shown and described herein may be interchanged as desired.

While the invention has been illustrated and described in detail in the foregoing drawings and description, the same is to be considered as illustrative and not restrictive in character, it being understood that only illustrative forms thereof have been show and described and that all changes and modifications that are within the scope of the following claims are desired to be protected.

What is claimed is:

1. A water ejection spout for connection to a swimming pool cover pump for removing water from a swimming pool cover, the water ejection spout comprising:
a length of flexible conduit;
a connector at one end of the length of flexible conduit, the connector configured for releasable attachment to a water outlet of a swimming pool cover pump; and
a nozzle formed integral with and at another end of the length of flexible conduit, the nozzle configured to eject water at an increased velocity relative to a velocity of the water from the swimming pool cover pump.

2. The water ejection spout of claim 1, wherein the length of flexible conduit is configured to allow repeated manipulation without compromise in order to shape the length of flexible conduit as desired.

3. The water ejection spout of claim 2, wherein the length of flexible conduit comprises one of plastic, metal, or rubber.

4. The water ejection spout of claim 2, wherein the length of flexible conduit comprises a combination of plastic, metal and/or rubber.

5. The water ejection spout of claim 2, wherein the nozzle is configured to adjust water ejection velocity.

6. The water ejection spout of claim 2, wherein the connector of the length of flexible conduit comprises one of a threaded, quick disconnect, and non-threaded connector.

7. A water ejection spout for connection to a swimming pool cover pump for expelling water from the swimming pool cover pump, the water ejection spout comprising:
a conduit having a first repeatedly positionable flexible portion;
a connector at one end of the conduit, the connector configured for releasable attachment to a water outlet of a swimming pool cover pump; and
a nozzle formed integral with and at another end of the conduit, the nozzle configured to eject water at an increased velocity relative to a velocity of the water from the swimming pool cover pump.

8. The water ejection spout of claim 7, wherein the conduit comprises one of plastic, metal, or rubber.

9. The water ejection spout of claim 7, wherein the conduit comprises a combination of plastic, metal and/or rubber.

10. The water ejection spout of claim 7, wherein the nozzle is configured to adjust water ejection velocity.

11. The water ejection spout of claim 7, wherein the nozzle is part of the first repeatedly positionable flexible portion.

12. The water ejection spout of claim 11, further comprising a second repeatedly positionable flexible portion and wherein the connector is associated with the second repeatedly positionable flexible portion.

13. A system for removing water from a swimming pool cover comprising:
a swimming pool cover pump having a water inlet and a water outlet; and
a conduit having a first repeatedly positionable flexible portion, a connector at one end of the conduit, the connector configured for releasable attachment to a water outlet of a swimming pool cover pump, and a nozzle formed integral with and at another end of the conduit, the nozzle configured to eject water at an increased velocity relative to a velocity of the water from the swimming pool cover pump.

14. The system of claim 13, wherein the conduit comprises one of plastic, metal, or rubber.

15. The system of claim 13, wherein the conduit comprises a combination of plastic, metal and/or rubber.

16. The system of claim 13, wherein the nozzle is configured to adjust water ejection velocity.

17. The system of claim 13, wherein the nozzle is part of the first repeatedly positionable flexible portion.

18. The system of claim 17, further comprising a second repeatedly positionable flexible portion and wherein the connector is associated with the second repeatedly positionable flexible portion.
